(19) United States
(12) Patent Application Publication
(10) Pub. No.: US 2019/0168326 A1
(43) Pub. Date: Jun. 6, 2019

(54) ELECTROCHEMICAL MACHINING APPARATUS FOR GEAR OUTLINE

(71) Applicant: METAL INDUSTRIES RESEARCH & DEVELOPMENT CENTRE, Kaohsiung City (TW)

(72) Inventors: YOU-LUN CHEN, KAOHSIUNG CITY (TW); DA-YU LIN, KAOHSIUNG CITY (TW); HUNG-YI CHEN, KAOHSIUNG CITY (TW); CHEN-WEI WU, KAOHSIUNG CITY (TW); CHIN-WEI LIU, KAOHSIUNG CITY (TW); ZHI-WEN FAN, KAOHSIUNG CITY (TW); CHIU-FENG LIN, KAOHSIUNG CITY (TW)

(21) Appl. No.: 15/855,031

(22) Filed: Dec. 27, 2017

(30) Foreign Application Priority Data
Dec. 1, 2017 (TW) 106142275

(51) Int. Cl. B23H 9/00; B23H 3/00; B23H 7/12

(52) U.S. Cl. CPC B23H 9/003; B23H 7/12; B23H 3/00

(57) ABSTRACT

The present invention relates to an electrochemical machining apparatus for gear outline, which is used for trimming the gear outline of the gear part of a workpiece and comprises a first moving mechanism, a second moving mechanism, a cathode electrode, and a gear alignment member. The cathode electrode is disposed at the first moving mechanism. The second moving mechanism is connected with the gear alignment member. The gear alignment member includes a plurality of alignment gears for aligning the location of a plurality of teeth of the gear part of the workpiece. Thereby, the plurality of teeth of the workpiece may correspond to the cathode electrode. Then, the cathode electrode may perform electrochemical machining on the plurality of teeth, and thus, trimming the outline of the plurality of teeth.

### FIELD OF THE INVENTION

The present invention relates generally to a machining apparatus, and particularly to an electrochemical machining apparatus for trimming the gear outline of the gears in a workpiece using electrochemical machining.

### BACKGROUND OF THE INVENTION

Gears are the most important component in mechanical transmission mechanisms. Thanks to their advantages of high transmission efficiency, accurate transmission ratio, and wide applications, gears are applied extensively in automobiles, aerospace, ships, instruments, and meters. As the requirements in the hardness, strength, wear resistance, and lifetime of gears in mechanical transmission designs become increasingly stringent, hardened gears are adopted generally.

Trimming of gears is normally arranged after thermal treatment. After thermal treatment, the hardness of gears will increase. If trimming of gears is performed by the cutting method according to the prior art, due to the large cutting force and high cutting temperature, cutting tools will wear seriously and gears will deform on the surface. Thereby, it is not appropriate to trim high-hardness gears using the cutting method according to the prior art. If a computer numerical control (CNC) machine tool is used to trim high-hardness gears, the machining cost will increase. In addition, there will be hard-to-remove flashes and burrs on the surface of the gears.

Accordingly, to solve to above technical drawbacks as described above, the present invention provides an electrochemical machining apparatus for gear outline for trimming the gear outline of the gears in a workpiece.

### SUMMARY

An objective of the present invention is to provide an electrochemical machining apparatus for gear outline, which adopts electrochemical machining to machine the gear outline of the gears in a workpiece.

Another objective of the present invention is to provide an electrochemical machining apparatus for gear outline, which adopts an alignment structure to align a plurality of teeth of the gears of a workpiece. Then the plurality of teeth of the workpiece may correspond to the cathode electrode, and the cathode electrode may perform electrochemical machining on the plurality of teeth and hence trimming the outline of the plurality of teeth.

The present invention discloses an electrochemical machining apparatus for gear outline, which comprises a base, a first moving mechanism, a cathode electrode, a gear alignment member, and a second moving mechanism. The first moving mechanism is disposed on the base. The cathode electrode is disposed at the first moving mechanism. The gear alignment member is disposed on the base and includes a plurality of alignment gears. The second moving mechanism is disposed on the base and connected with the gear alignment member.

### BRIEF DESCRIPTION OF THE DRAWINGS

FIG. 1 shows a stereoscopic diagram of the electrochemical machining apparatus according to an embodiment of the present invention;

FIG. 2A shows a cross-sectional view of a partial structure of the electrochemical machining apparatus according to an embodiment of the present invention;

FIG. 2B shows an enlarged view of the cross-sectional view of a partial structure in FIG. 2A;

FIG. 2C shows an exploded view of a partial structure of the electrochemical machining apparatus according to an embodiment of the present invention;

FIG. 3 shows a schematic diagram of the gear alignment member of the electrochemical machining apparatus moving and projecting the contour alignment structure according to an embodiment of the present invention;

FIG. 4 shows a cross-sectional view of the workpiece according to an embodiment of the present invention;

FIG. 5 shows a schematic diagram of aligning the workpiece using the electrochemical machining apparatus according to an embodiment of the present invention;

FIG. 6 shows a schematic diagram of pressing the workpiece using the electrochemical machining apparatus according to an embodiment of the present invention;

FIG. 7A shows a schematic diagram of moving the cathode electrode to enter the workpiece for trimming the tooth outline of the gear of the workpiece using the electrochemical machining apparatus according to an embodiment of the present invention;

FIG. 7B shows a cross-sectional view of a partial structure in FIG. 7A;

FIG. 8 shows a block diagram of the control circuit according to an embodiment of the present invention;

FIG. 9A shows a bottom view of the gear when the cathode electrode corresponds to the workpiece according to the present invention; and

FIG. 9B shows a partially enlarged view of FIG. 9A.

### DETAILED DESCRIPTION

In order to make the structure and characteristics as well as the effectiveness of the present invention to be further understood and recognized, the detailed description of the present invention is provided as follows along with embodiments and accompanying figures.

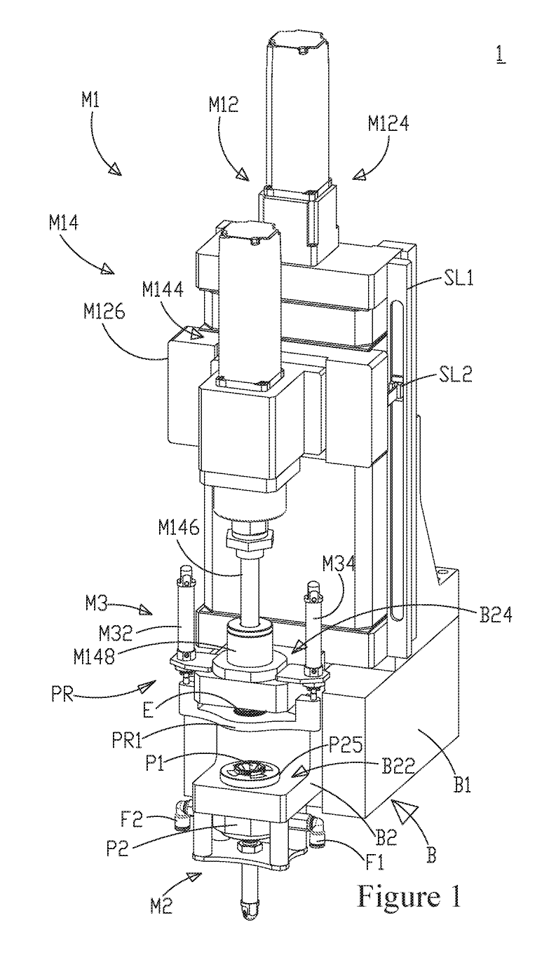

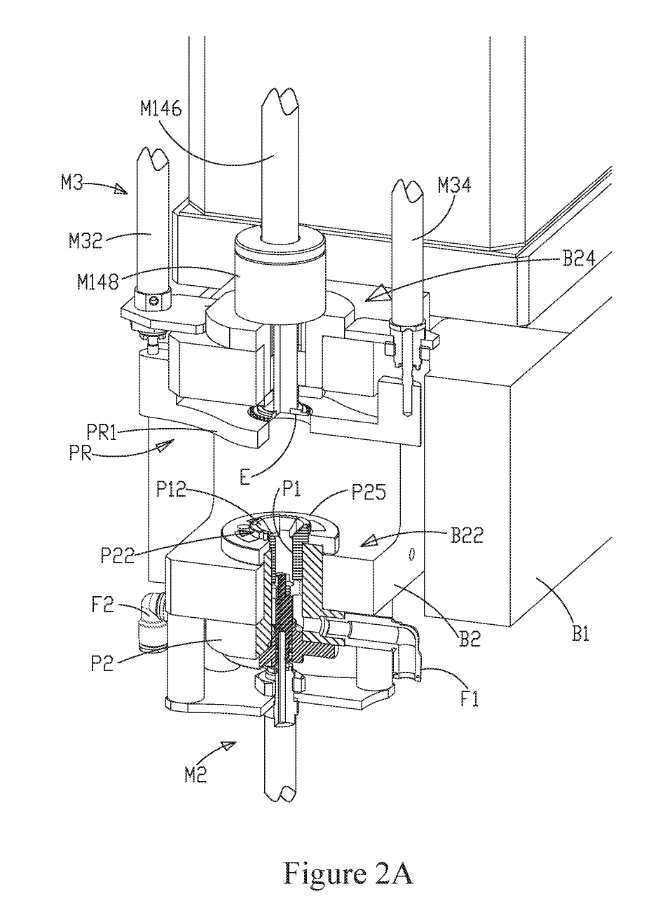

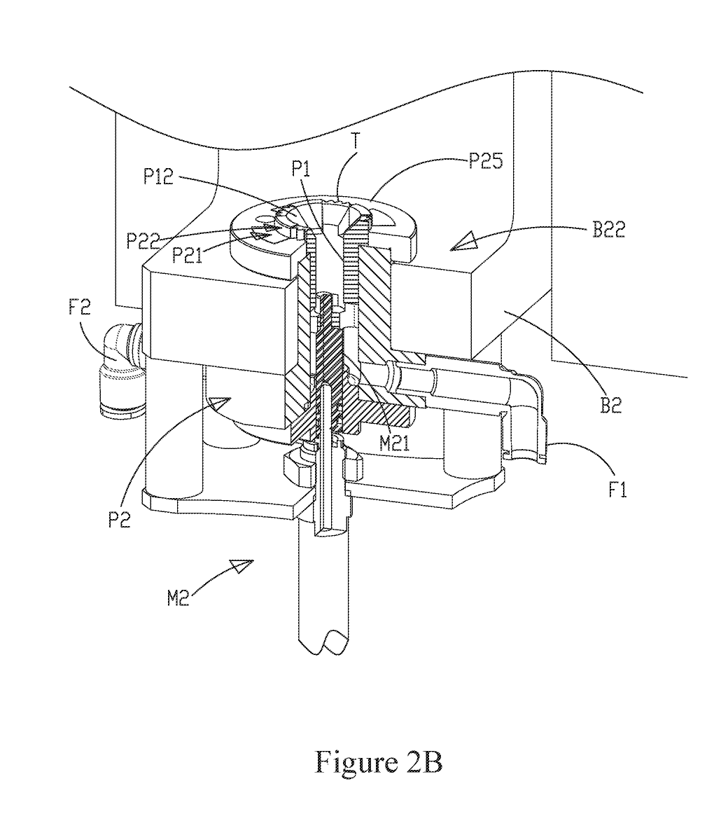

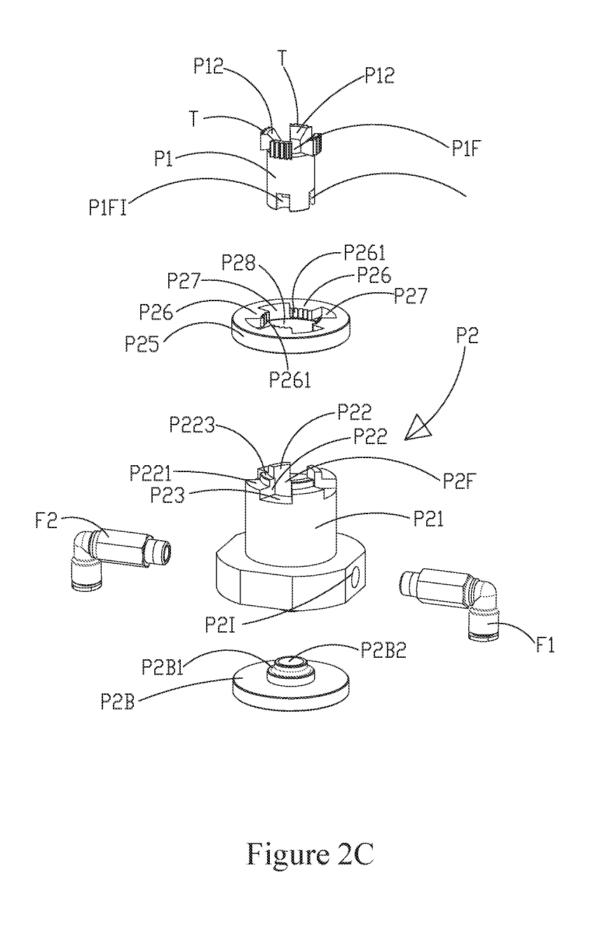

Please refer to FIG. 1, FIG. 2A, and FIG. 2B, which show a stereoscopic diagram, a cross-sectional view of a partial structure of the electrochemical machining apparatus according to an embodiment of the present invention and an enlarged view of the cross-sectional view of a partial structure in FIG. 2A. As shown in the figures, the present invention provides an electrochemical machining apparatus 1, which is used for performing electrochemical machining on the tooth outline of the gear W1 of a workpiece W. The electrochemical machining apparatus 1 comprises a base B, a first moving mechanism M1, a cathode electrode E, a gear alignment member P1, and a second moving mechanism M2. The base B includes a body B1 and a carrier B2. The carrier B2 is disposed on the front side of the body B1. The body B1 and the carrier B2 are formed integrally. The carrier B2 includes a first platform B22 and a second platform B24. The second platform B24 is locate above the first platform B22 with a gap therebetween. The first moving mechanism M1 is disposed on the body B1 of the base B. The cathode electrode E is disposed at the first moving mechanism M1. The gear alignment member P1 is disposed on the first platform B22 of the carrier B2 of the base B and includes a plurality of alignment teeth T, as shown in FIG. 2C. Besides, the second moving mechanism M2 is disposed on the base B and connected with the gear alignment member P1.

The first moving mechanism M1 may include a linear moving mechanism M12 and a rotating mechanism M14. The linear moving mechanism M12 is disposed at the body B1 of the base B. The rotating mechanism M14 is disposed at the linear moving mechanism M12. The linear moving mechanism M12 carries the rotating mechanism M14 to perform linear movement. The cathode electrode E is connected to the rotating mechanism M14, which rotates the cathode electrode E. The linear moving mechanism M12 may include a linear driving device M124 and a linear moving member M126. The linear driving device M124 may be a linear motor. The linear driving device M124 is connected with the linear moving member M126 for driving the linear moving member 126 to perform linear motion.

The rotating mechanism M14 includes a spin driving device M144, which is disposed at the linear moving member M126. The spin driving device M144 is further connected with the cathode electrode E for rotating the cathode electrode E. The spin driving device M144 may be a spin motor. In addition, the linear moving mechanism M12 may further include one or more sliding track SL1 and one or more sliding member SL2. The sliding track SL1 is disposed on both sides of the body B1; the sliding member SL2 is connected to both sides of the linear moving member M126. The sliding member SL2 is located and slidable on the sliding track SL1. Moreover, the rotating mechanism M14 may further include a connecting rod M146, which is connected with the spin driving device M14 and passes through an alignment member M148 for connecting to the cathode electrode E. The spin driving device M144 spins the connecting rod M146 for rotating the cathode electrode E. The alignment member M148 is disposed on the second platform B24 of the carrier B2 for aligning the connecting rod M146.

As shown in FIG. 2B and FIG. 2C, the electrochemical machining apparatus 1 may further include a contour alignment structure P2 disposed on the first platform P12 of the carrier B2 of the base B. The gear alignment member P1 is put around the contour alignment structure P2 coaxially. The gear alignment member P1 includes a plurality of first alignment parts P12 spaced with one another. Each first alignment part P12 includes the plurality of alignment teeth T. The gear alignment member P1 may be hollow; and the plurality of first alignment parts P12 may be blocks.

The contour alignment structure P2 may include an alignment sleeve P21 and an annular member P25. The alignment sleeve P21 may be hollow and include a plurality of second alignment parts P22. Namely, the contour alignment structure P2 includes the plurality of second alignment parts P22. The plurality of second alignment parts P22 are located on the top of the alignment sleeve P21 and spaced with one another. They may be staircase-shaped and include first staircase parts P221 and second staircase parts P223. The alignment sleeve P21 may include a plurality of recess parts P23 located between the plurality of second alignment parts P22, respectively. The bottom surfaces of the plurality of recess parts P23 are lower than the surfaces of the plurality of first staircase parts P221. The outer periphery of the plurality of second staircase parts P223 may be curved.

The annular member P25 includes a plurality of limiting parts P26, a plurality of recess parts P27, and a hollow part P28. The plurality of limiting parts P26 and plurality of recess parts P27 are all located on the inner side of the annular member P25. The plurality of limiting parts P26 are space with one another and correspond to the plurality of recess parts P23 of the alignment sleeve P21. Each limiting part P26 includes a plurality of limiting teeth P261 and is located on the surface of the limiting part P26. The plurality of limiting parts P26 may be blocks. The plurality of recess parts P27 are located between the plurality of limiting parts P26, respectively, and correspond to the plurality of first staircase parts P221 of the alignment sleeve P21, respectively. The hollow part P28 is located the central part of the annular member 25 and connects with the plurality of recess parts P27. The annular member P25 may be put around the alignment sleeve P21. The plurality of limiting parts P26 of the annular member P25 are accommodated in the plurality of recess parts P23 of the alignment sleeve P21. The plurality of first staircase parts P221 of the plurality of second alignment parts P22 of the alignment sleeve P21 are accommodated in the plurality of recess parts P27 of the annular member P25. The alignment sleeve P21 and the annular member P25 may be formed integrally to give the contour alignment structure P2.

The gear alignment member P1 is put around the contour alignment structure P2 coaxially. In addition, the plurality of first alignment parts P12 of the gear alignment member P1 are located between the plurality of second alignment parts P22 of the contour alignment structure P2, respectively. Thereby, the plurality of first alignment parts P12 of the gear alignment member P1 and the plurality of second alignment parts P22 of the contour alignment structure P2 are interlaced and hence locating in an annular arrangement. Furthermore, the plurality of first alignment parts P12 of the gear alignment member P1 correspond to the plurality of limiting parts P26 of the annular member P25, respectively, and the plurality of alignment teeth T of the plurality of first alignment parts P12 may be wedged in the plurality of limiting teeth P261 of the plurality of limiting parts P26. The plurality of alignment teeth T may move up and down along the plurality of limiting teeth P261. The plurality of limiting teeth P261 may prevent the plurality of alignment teeth T from rotating and thus limiting the location of the plurality of alignment teeth T. The contour alignment structure P2 may be a conductive electrode.

The gear alignment member P1 and the contour alignment structure P2 are both disposed on the carrier B2 of the base B. The alignment sleeve P21 of the contour alignment structure P2 passes through the first platform B22 from the bottom of the first platform B22. The bottom of the alignment sleeve P211 is disposed against the bottom of the first platform B22. The annular member P25 is put coaxially around the top of the alignment sleeve P21. The gear alignment member P1 passes from the top of the first platform B22 and goes down coaxially through the annular member P25 and the alignment sleeve P21.

As shown in FIG. 2B and FIG. 2C, a bottom lid P2B is disposed at the bottom of the alignment sleeve P21 and includes a bottom sealant P2B1 and a hole P2B2. The bottom sealant P2B1 projects from the top surface of the bottom lid P2B; the hole P2B2 penetrates the bottom lid P2B and the bottom sealant P2B1. A moving rod M21 of the second moving mechanism M2 passes through the hole P2B2 and is connected to the bottom of the gear alignment member P1 for driving the gear alignment member P1 to move. The second moving mechanism M2 may be a pneumatic cylinder or a hydraulic cylinder.

In addition, the gear alignment member P1 includes a first channel P1F and a plurality of electrolyte inlets P1FI. The first channel P1F is located at the central region of the gear alignment member P1. The plurality of electrolyte inlets P1FI are located on the sidewall of the bottom of the gear alignment member P1 and communicate with the first channel P1F. The contour alignment structure P2 includes a second channel P2F and a plurality of electrolyte inlets P21. The second channel P2F is located at the central region of the alignment sleeve P21. The plurality of electrolyte inlets P21 are located on the sidewall of the bottom of the alignment sleeve P21 and communicate with the second channel P2F. The plurality of electrolyte inlets P21 are connected with a first transport connector F1 and a second transport connector F2, respectively. The gear alignment member P1 is accommodated in the second channel P2F. Thereby, the plurality of electrolyte inlets P1FI and the first channel P1F of the gear alignment member P1 communicate with the second channel P2F.

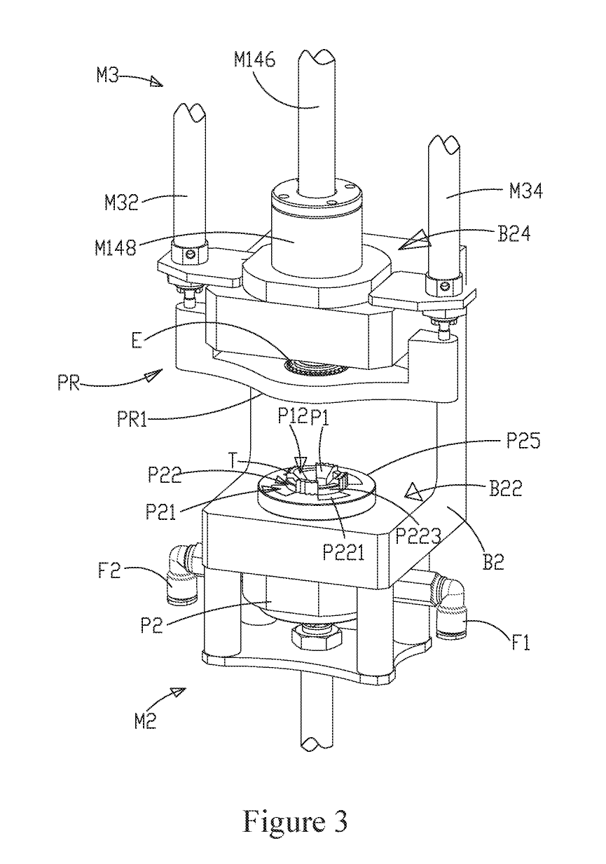

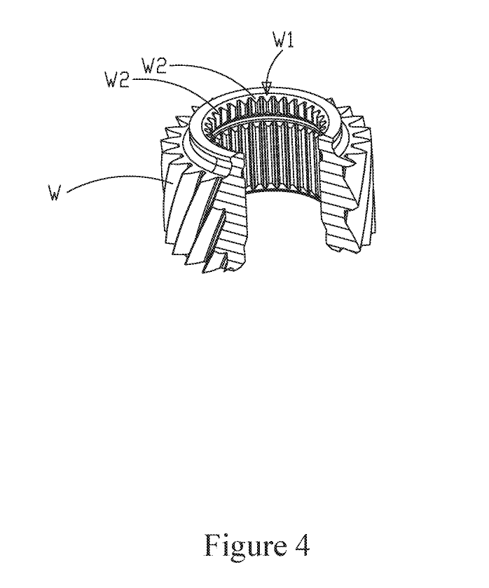

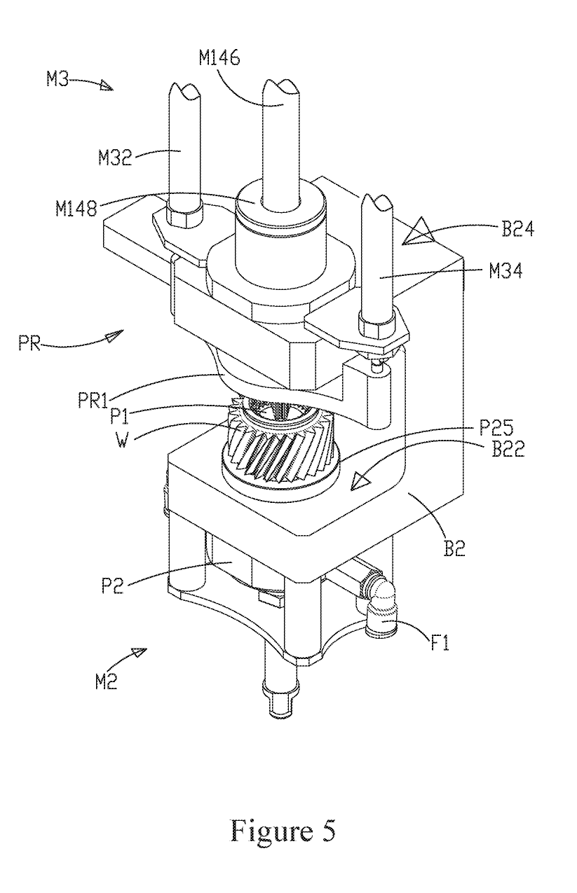

Please refer to FIG. 3, which shows a schematic diagram of the gear alignment member of the electrochemical machining apparatus moving and projecting the contour alignment structure according to an embodiment of the present invention. As shown in the figure, the second moving mechanism M2 pushes the gear alignment member P1, enabling the plurality of first alignment parts P12 of the gear alignment member P1 to project from the alignment sleeve P21 of the contour alignment structure P2. Hence, the plurality of alignment teeth T of the plurality of first alignment parts P12 are higher than the plurality of second alignment parts P22 of the alignment sleeve P21. As shown in FIG. 4, the workpiece W includes a gear part W1, which includes a plurality of inner teeth W2. The outer peripheries of the plurality of second staircase parts P223 of the plurality of second alignment parts P22 correspond to the inner periphery of the workpiece W. Thereby, as shown in FIG. 5, when the workpiece W is placed on the annular member P25 of the contour alignment structure P2 and the plurality of first staircase parts P221 (as shown in FIG. 3), the workpiece W is put around the plurality of second staircase parts P223 of the contour alignment structure P2 (as shown in FIG. 3), making the workpiece W unable to move horizontally. Besides, the tooth shape of the plurality of alignment teeth T of the gear alignment member P2 (as shown in FIG. 3) corresponds to the tooth shape of the plurality of inner teeth W2 of the workpiece W and hence the plurality of inner teeth W2 of the workpiece W are wedged into the plurality of alignment teeth T of the gear alignment member P1. Thereby, the workpiece W is unable to rotate because the location of the plurality of inner teeth W2 of the workpiece W is aligned.

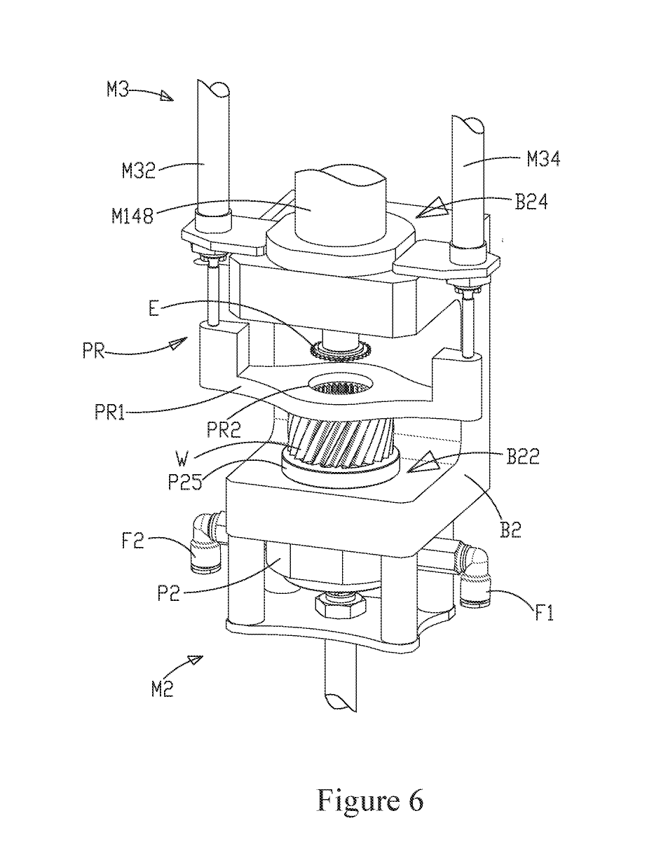

Please refer to FIG. 6, which shows a schematic diagram of pressing the workpiece using the electrochemical machining apparatus according to an embodiment of the present invention. As shown in FIG. 6, the electrochemical machining apparatus 1 may further include a pressing mechanism PR disposed on the base B and opposing to the gear alignment member P1 (as shown in FIG. 3). The pressing mechanism PR includes a third moving mechanism M3 and a pressing member PR1. The third moving mechanism M3 is disposed on the second platform B24 of the base B2; the pressing member PR1 is connected with the third moving mechanism M3 and opposing to the gear alignment member P1. The third moving mechanism M3 includes a first moving member M32 and a second moving member M34 disposed on both sides of the second platform B24, respectively, and connected with both sides of the pressing member PR1, respectively. The pressing member PR1 includes an opening PR2 corresponding to the workpiece W and the cathode electrode E. The first moving member M32 and the second moving member M34 may be pneumatic cylinder or a hydraulic cylinder.

The third moving mechanism M3 pushes the pressing member PR1 and thus pressing the workpiece W for avoiding the workpiece W from moving. In addition, the second moving mechanism M2 drives the gear alignment member P1 to move downward. Then the plurality of first alignment parts P12 of the gear alignment member P1 exit from the inside of the workpiece W and recover to the status shown in FIG. 2B. The plurality of alignment teeth T of the plurality of first alignment parts P12 are higher than the plurality of second alignment parts P22 of the alignment sleeve P21.

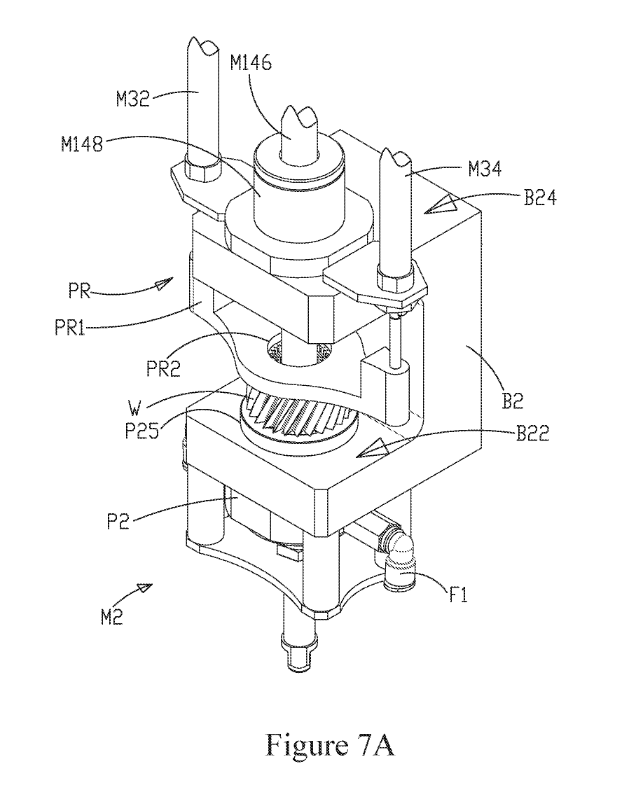

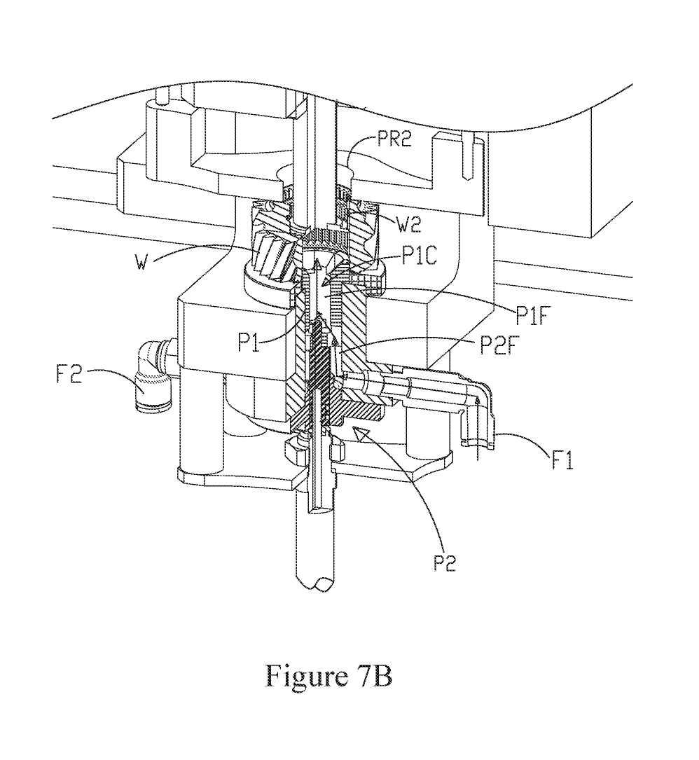

Please refer to FIGS. 1, 7A, and 7B, the first moving mechanism M1 moves the cathode electrode E downward. The cathode electrode E passes through the opening PR2 of the pressing member PR1, reaches the inside of the workpiece W, and corresponds to the plurality of inner teeth W2 for trimming the outline of the plurality of inner teeth W2 of the workpiece W. In other words, the outline of the cathode electrode E is just the outline of the tooth shape.

As shown in FIG. 7B, the second channel P2F of the contour P2 connects with the first channel P1F of the gear alignment member P1, and the first channel P1F is located at the central region P1C of the gear alignment member P1. Thereby, the electrolyte transported by the first transport connector F1 and the second transport connector F1 may pass along the second channel P2F and the first channel P1F and then inject to the plurality of inner teeth W2 of the workpiece W. Besides, the cathode electrode E is coupled to the cathode of the power supply (not shown in the figure); the contour alignment structure P2 is coupled to the anode of the power supply (not shown in the figure). It means that the workpiece W is coupled to the anode of the power supply. Thereby, the cathode electrode E may perform electrochemical machining on the plurality of inner teeth W2 of the workpiece W for trimming the outline of the plurality of inner teeth W.

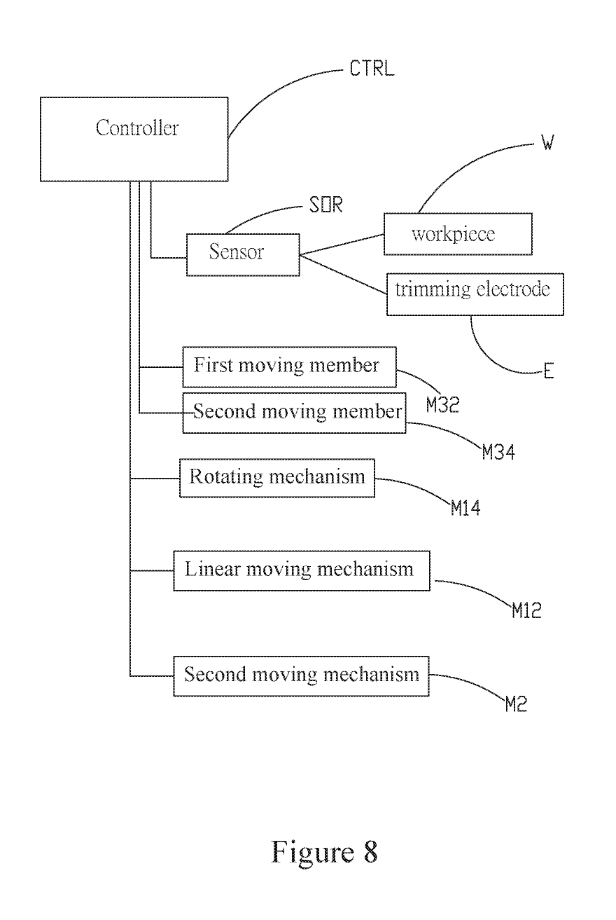

Please refer FIG. 8, which shows a block diagram of the control circuit according to an embodiment of the present invention. As shown in the figure, the electrochemical machining apparatus 1 further comprises a controller CTRL, which coupled to a sensor SOR, the linear moving mechanism M12 and the rotating mechanism M14 of the first moving mechanism M1, the second moving mechanism M2, the first moving member M32 and the second moving member M34 of the third moving mechanism M3. The controller CTRL controls the linear moving mechanism M12, the rotating mechanism M14, the second moving mechanism M2, the first moving member M32, and the second moving member M34.

The sensor SOR may be disposed on the base B and coupled to the contour alignment structure P2 and the cathode electrode E for detecting the electrical status, for example, the current status, of the cathode electrode E and the workpiece W. Then the controller CTRL may control the rotating mechanism M14 according to the electrical status. Before the electrochemical machining apparatus 1 starts to trim the plurality of inner teeth W2 of the workpiece W, the controller CTRL controls the rotating mechanism M14 to spin for aligning the relative position of the trimming teeth E2 of the cathode electrode E and the plurality of inner teeth W.

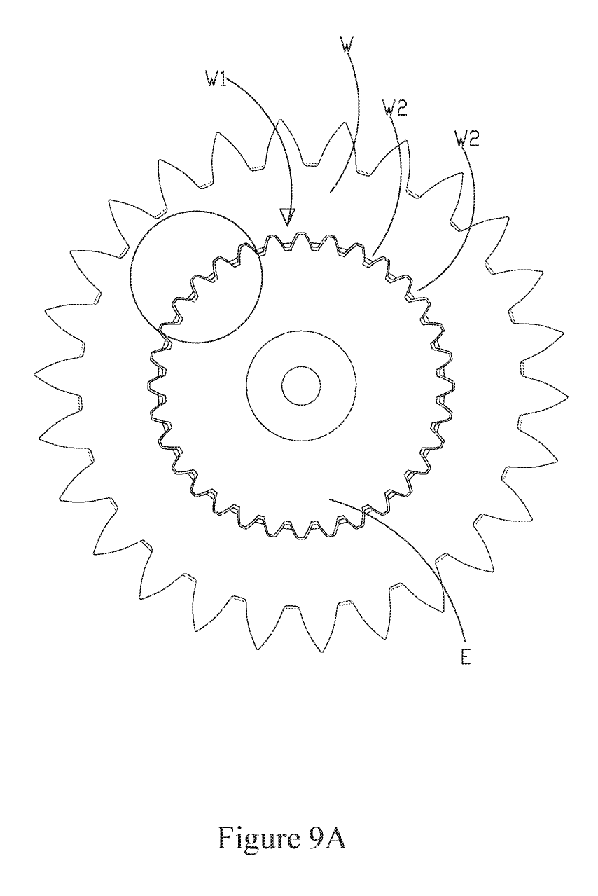

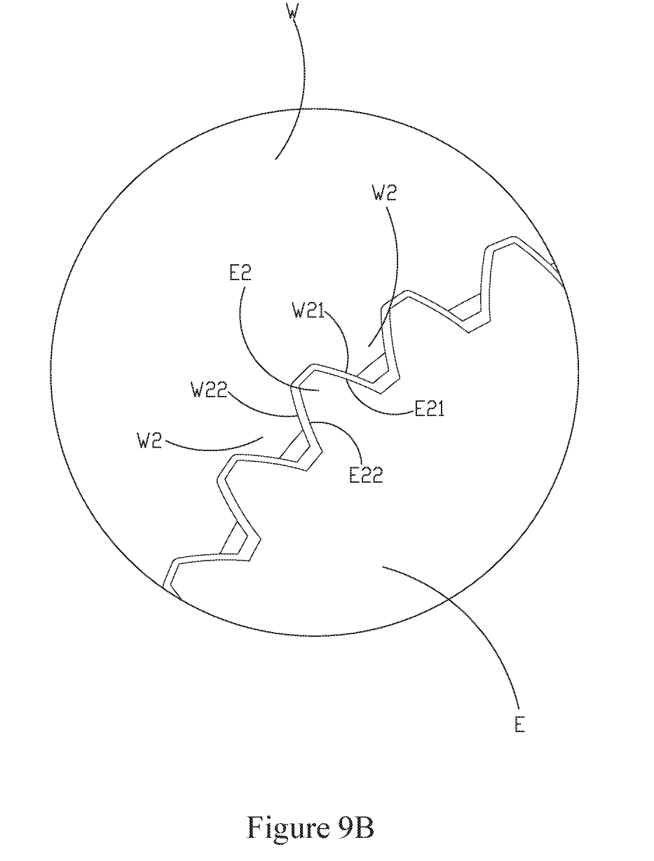

As shown in FIGS. 9A and 9B, the controller CTRL controls the rotating mechanism M14 to spin clockwise so that the periphery E21 of the trimming teeth E2 of the cathode electrode E touches slightly the periphery W21 of the inner teeth W2. At this moment, the sensor SOR may sense that the trimming teeth E2 and the inner teeth W2 are in short circuit and generate and transmit a sensing signal to the controller CTRL. Then the controller CTRL knows that the cathode electrode E and the workpiece W are in electrical short circuit. It controls the rotating mechanism M14 to stop spinning clockwise. Instead, it enables the rotating mechanism M14 to spin counterclockwise and records the angle at which the rotating mechanism M14 spins counterclockwise until the sensor SOR senses another short circuit between the trimming teeth E2 and the inner teeth W2. It means that the periphery E22 of the trimming teeth E2 touches slightly the periphery W22 of the inner teeth W2. Then the controller CTRL controls the rotating mechanism M14 to step spinning counterclockwise. The controller CTRL may deduce the gap between the trimming teeth E2 and the inner teeth W2 according to the recorded angle. Hence, it may control the rotating mechanism M14 to spin clockwise for moving the trimming teeth E2 to the central position between the periphery W21 and periphery W22 of the inner teeth W2. Accordingly, the distance between the periphery E21 of the trimming teeth E2 and the periphery W21 of the inner teeth W2 is equal to the distance between the periphery E22 of the trimming teeth E2 and the periphery W22 of the inner teeth W2. Then the trimming accuracy may be improved.

To sum up, the present invention provides an electrochemical machining apparatus, which uses an electrochemical machining method for trimming the gear outline of the gear part of a workpiece. The electrochemical machining apparatus uses an angular alignment member to align the location of a plurality of teeth of the gear part. Then the plurality of teeth of the workpiece may correspond to the cathode electrode and the cathode electrode may perform electrochemical machining on the plurality of teeth and trimming the outline of the plurality of teeth. The electrochemical machining apparatus may trim workpiece with high hardness as well as avoiding flashes and burrs on the workpiece. In addition, the channel is disposed at the gear alignment member. The gear alignment member may be further disposed coaxially with the contour alignment structure. Thereby, the gear alignment member may combine with the contour alignment structure and the channel to form a compound structure.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. An electrochemical machining apparatus for gear outline, comprising:
a base;
a first moving mechanism, disposed on said base;
a cathode electrode, disposed at said first moving mechanism;
a gear alignment member, disposed on said base, and including a plurality of alignment teeth; and
a second moving mechanism, disposed on said base and connected with said gear alignment member.

2. The electrochemical machining apparatus for gear outline of claim 1, and further comprising a contour alignment structure, disposed on said base, and said gear alignment member put coaxially around said contour alignment structure.

3. The electrochemical machining apparatus for gear outline of claim 2, wherein said gear alignment member includes a plurality of first alignment parts spaced to one another, and said plurality of first alignment parts including said plurality of alignment teeth, respectively; said contour alignment structure includes a plurality of second alignment parts spaced to one another; said gear alignment member is coaxially put around said contour alignment structure; said plurality of first alignment parts of said gear alignment member are located between said plurality of second alignment parts of said contour alignment structure, respectively; and said plurality of first alignment parts are interlaced with said plurality of second alignment parts, respectively, and locating in an annular arrangement.

4. The electrochemical machining apparatus for gear outline of claim 2, wherein said gear alignment member includes a first channel; said contour alignment structure includes a second channel; and said second channel connects with said first channel.

5. The electrochemical machining apparatus for gear outline of claim 4, wherein said first channel is located at a central region of said gear alignment member.

6. The electrochemical machining apparatus for gear outline of claim 2, wherein said contour alignment structure is a conductive electrode.

7. The electrochemical machining apparatus for gear outline of claim 1, wherein said first moving mechanism includes:
a linear moving mechanism, disposed on said base; and
a rotating mechanism, disposed at said linear moving mechanism, and connected with said cathode electrode.

8. The electrochemical machining apparatus for gear outline of claim 7, and further comprising a controller, coupled to said rotating mechanism, detecting an electrical status of said cathode electrode, and controlling said rotating mechanism according to said electrical status.

9. The electrochemical machining apparatus for gear outline of claim 1, and further comprising a pressing mechanism, disposed on said base, and opposing to said gear alignment member.

10. The electrochemical machining apparatus for gear outline of claim 9, wherein said pressing mechanism includes:
a third moving mechanism, disposed on said base; and
a pressing member, connected with said third moving mechanism, and opposing to said gear alignment member.
